(19) United States
(12) Patent Application Publication
(10) Pub. No.: US 2008/0255874 A1
(43) Pub. Date: Oct. 16, 2008

(54) SYSTEM AND METHOD FOR DELIVERING CLINICAL NOTIFICATIONS

(75) Inventors: STEVEN S. CROOKS, Gladstone, MO (US); CHRISTOPHER S. FINN, Liberty, MO (US); DAVID P. MCCALLIE, Stilwell, KS (US); DAVID J. O'LARTE, Peculiar, MO (US)

Correspondence Address: SHOOK, HARDY & BACON L.L.P.;Intellectual Property Department, 2555 GRAND BOULEVARD, KANSAS CITY, MO, 64108-2613, US

(73) Assignee: CERNER INNOVATION, INC., Overland Park, KS (US)

(21) Appl. No.: 11/735,547

(22) Filed: Apr. 16, 2007

(51) Int. Cl. G06Q 50/00

(52) U.S. Cl. 705/2

(57) ABSTRACT

A system and associated methods are disclosed for managing clinical notification delivery and related compliance monitoring. In certain embodiments, the clinical notifications are automatically driven by healthcare information associated with a specific patient, and are delivered to an electronic device of the patient at a remote location. Thereafter, compliance monitoring may be initiated to log the patient's intent to act in accordance with the notification. For instance, in certain embodiments, the notification relates to a reminder regarding scheduled medication administration for the particular patient, where a reply to the notification indicates whether the patient is following the scheduled medication administration.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

In the delivery of healthcare services, one issue of concern is the administration of medications to individuals. This can be especially problematic when an individual is self-administering medications. For instance, a physician or other clinician prescribing a specific medication to treat a particular ailment or condition expects the individual to take the medication according to the recommended dosage administration schedule. However, compliance with a given medication administration schedule can prove to be quite difficult for many people. As an example, it is not uncommon for an individual to have a number of current prescriptions for a wide variety of medications, some of which may require multiple dosing events per day. Keeping the administration schedule for each medication in order can be quite challenging, with serious adverse (or atypical) effects potentially arising if a scheduled administration event is missed or delayed. Not only would the individual fail to receive the desired therapeutic effect intended by the clinician, but the chances for unintended drug-drug interactions may also increase. Other health-related factors may also affect prescription non-compliance, such as age-related disease in elderly patients, or other cognitive and physical impairments interfering with an individual's ability to self-administer medications effectively.

Various concepts have been developed to address the issue of non-compliance with medication administration. For instance, pill organizers and the like provide a set of compartments into which one or more medication doses may be placed. Each compartment is labeled with a date or time stamp, such as a day of the week, denoting when each medication dose should be taken by the individual. The pill organizer is therefore pre-loaded with the medication doses the individual needs for a certain period of time according to the prescribed schedule, reducing the chance that the individual would fail to take a given medication dose at the scheduled time. Additionally, an individual may choose to enter (i.e., upload) their current medication administration schedule into an electronic system that generates certain types and/or forms of reminders at times corresponding with the schedule entered.

Unfortunately, current medication administration compliance techniques have disadvantages. With traditional pill organizers and the like, the individual may still forget to take the medication doses in a given compartment on the denoted date/time. Also, a pill organizer is limited by the number and configuration of the medication compartments. If an individual has a complicated dosage administration schedule, the compartment design may not be adequate to guide the individual in keeping with the schedule. With respect to current reminder systems, errors may arise if an individual fails to enter their complete and accurate medication administration schedule into the system. Additionally, for accurate reminders regarding medication administration, the individual has to constantly engage in the uploading process each time a new prescription is written, which can be a laborious process. Accordingly, errors in medication administration compliance due to scheduling issues are still quite prevalent.

### BRIEF SUMMARY

Embodiments of the system and methods of the present invention provide for delivering clinical notifications. In particular, the system and methods rely on sources of healthcare information for generating various types of person-specific notifications, such as reminders relating the administration of a particular medication dose, which are transmitted to electronic devices associated with the respective persons. Thereafter, compliance information regarding medication administration may be registered by the system.

In one aspect, a computerized method enables the delivery of medication information to a remotely located individual. According to the method, medication information is acquired from a source of healthcare information associated with the remotely located individual. Examples of sources of such information include a health record of the individual or medical claims associated with the individual. Based on the particular medication information acquired, a signal is generated and transmitted to an electronic device associated with the remotely located individual. The signal generated and transmitted to the electronic device may include information of various types relating to the remotely located individual, such as a notification related to a scheduled administration time for a specific medication, instructions for administering a specific medication, contact information for an entity providing information surrounding the administration of a specific medication, and a reminder of the need for a prescription renewal. Furthermore, the signal may include a command signal instructing the electronic device to provide a means for establishing a communication link with an entity providing information surrounding the administration of a specific medication. In situations where the electronic device is a medication housing device, the command signal may instruct the device to provide an indication that the command signal was received, such as a visual or audible alert. This informs the individual about a condition surrounding the scheduled administration of a specific medication, such as timing for taking certain preselected medications.

In another aspect, a method provides for managing electronic communications surrounding healthcare reminders. According to the method, clinical information is acquired from a source of healthcare information associated with a remotely located individual. This source may include, for example, a health record of the individual or medical claims associated with the individual. Based on the particular clinical information acquired, a reminder signal is generated and transmitted to an electronic device associated with the remotely located individual. The reminder signal generated and transmitted to the electronic device may include, for instance, information regarding scheduled medication administration for the remotely located individual, a scheduled appointment for the remotely located individual, or a prescription renewal for the remotely located individual.

With respect to another aspect, the method for managing electronic communications related to healthcare reminders may also provide additional functionality through reply signals from the electronic device associated with the remotely located individual. Thus, after the generation and transmission of a reminder signal to the individual's electronic device, a reply is received from the electronic device that includes information such as an indication as to whether the remotely located individual received a notification regarding scheduled medication administration, an indication that the individual plans to or has complied with a scheduled medication administration event, a request for information regarding a specific medication, or a request for assistance regarding medication administration.

In yet another aspect, a computerized method facilitates compliance with scheduled medication administration for a remotely located individual. According to the method, a reminder signal is generated based on an administration schedule for a specific medication, the schedule being acquired from a source of healthcare information associated with the individual. The reminder signal is transmitted to an electronic device associated with the remotely located individual. Thereafter, depending on certain interactions with the electronic device (e.g., by the remotely located individual), a reply is received from the electronic device indicative of activity surrounding the scheduled administration of the specific medication. The electronic device may be in the form of an electronic medication housing device that provides an indication of the receiving of a signal relating to a reminder regarding medication administration (e.g., in the form of a visual or audible alert). The indication may also specifically direct the individual to remove preselected medications from the devices. In this case, the reply from the electronic medication housing device relates to registering access to a certain portion of the medication housing device, such as the compartment where the preselected medications are located. Alternatively, activity of the electronic medication housing device may be controlled by a portable communication device that also serves as the electronic device that receives the reminder signal and generates the reply. In this case, after receiving the reminder signal, the portable communication device generates and transmits a command signal to the electronic medication housing device that instructs the housing device to provide an indicator conveying a reminder regarding medication administration. Thereafter, a reply from the medication housing device relating to registering of access to a certain portion of the medication housing device is transmitted to the portable communication device, which forms the content of the reply indicative of activity surrounding the scheduled administration of the specific medication. Optionally, the content of the reply received may be stored in a health record, personalized health bank or other record associated with the particular individual, so that compliance with a medication administration regime by the individual is recorded.

Through the various embodiments of system and methods, clinical notifications surrounding information associated with an individual are transmitted to an electronic device of the individual. In particular, the system and methods facilitate the automated delivery of medication information and clinical reminders to an individual, while providing a feedback loop where compliance with the reminders may be registered.

Additional advantages and features of the invention will be set forth in part in a description which follows, and in part will become apparent to those skilled in the art upon examination of the following, or may be learned by practice of the invention.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing system environment suitable for use in implementing the present invention;

FIG. 2 is a schematic view of an exemplary electronic communication device functioning within the computing system environment of FIG. 1;

FIG. 3 is a flow diagram illustrating a method for managing healthcare reminders and associated compliance feedback;

FIG. 4 is a flow diagram illustrating a method for managing healthcare reminders and conditions surrounding access to preselected medications in accordance with medication administration scheduling; and

FIG. 5 is an illustrative view of the exemplary electronic communication device of FIG. 2, presenting selection options on a display screen based on the notification received.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

The system and methods of the present invention facilitate the delivery of clinical notifications to person-specific electronic devices at remote locations. Certain embodiments of the system and methods also provide for compliance checking via two-way communications, so that a specific electronic device can indicate whether the associated person has acknowledged receipt of the notification and plans to act in accordance with the information contained in the notification. In embodiments, the clinical notifications are driven by healthcare information that is associated with the person assigned to a specific electronic device. For instance, the healthcare information may be retrieved from a health record of the individual (e.g., an electronic medication record (EMR), a health bank, a community health record), or from medical claims relating to healthcare delivery events associated with the individual. Additional clinical information presented in context with or based on the particular individual's healthcare information may be retrieved from an information source, such as a clinical knowledge base. As one example, if the notification is a reminder for the specific person to self-administer a prescribed medication dose, a graphical representation such as a picture of the respective medication dose may be retrieved from an information source and transmitted to the individual's electronic device in conjunction with any textual instructions relating to dosage administration.

The clinical notifications also may be of various types. One exemplary clinical notification type includes reminders regarding medication administration or clinical appointments for the respective individual. Such a reminder may inform the individual about when to take a dose of a prescribed medication, when to renew a prescription (e.g., based on the expiration of the prescription or predicted number of doses left), or that a scheduled appointment is upcoming. It will be appreciated that other types of reminders may also be provided. Further, in addition to reminders, clinical notifications provide additional context, such as the delivery of medication information requested by the individual and/or links to certain clinical information sources. In such contexts, exemplary notifications include: a current medication profile for the individual (e.g., currently and recently prescribed medications); a medication administration schedule for one or more prescribed medications for the individual; an identification of unknown medications the individual possesses (e.g., via a prescription ID or barcode present on a medication container), in response to user activity on the electronic device; or other clinical information. Furthermore, notifications may include command signals to cause the person-specific electronic device to initiate additional activities. Some examples of the activities initiated in response to the command signals include: communication with an electronically controlled medication housing device, instructing such device to provide an indication of what portion of the housing should be accessed for a current medication dose; and display of graphical or textual links that provide a means for reaching additional clinical information resources.

In embodiments where compliance checking is active, the system awaits a reply signal from the person-specific electronic device. The reply signal may be generated by a certain interaction (or lack thereof) by the individual with the electronic device. For instance, the individual may make certain inputs on the device, which cause a reply signal to be generated and transmitted back through the system to indicate conditions surrounding receipt of the notification and any information as to whether the individual will act in accordance with the information contained in the notification (e.g., whether a medication dose will be taken as scheduled). Inputs may be directly on the electronic device, or through other devices coupled with the person-specific electronic device. As examples, inputs may be made on an electronically controlled medication housing device that registers whether a user accessed certain compartments of the device and relays such activity back to the person-specific electronic device, or on a barcode scanner coupled with the person-specific electronic device, whereby scanning of a barcode on a medication container indicates the individual's intent to self-administer a medication dose. Additionally, in the case of compliance with medication administration for the specific individual, the reply process enables caregivers with the ability to employ “Five Rights” checking to ensure that a medication administration event takes into consideration the following: the right medication, the right dose, the right time of administration, the right route of administration, and the right patient or individual to be taking the medication.

As another feature, certain embodiments of the system and methods provide notifications in various electronic formats, such as textual, graphical or other visual forms, audible, vibratory, or any combination of these types. Textual notifications provided to the person-specific electronic devices may include general or specific healthcare information, including optionally, dynamic links to additional clinical information, such as a hyperlink to a clinically-relevant data source (e.g., an informational website about a prescribed medication). Graphical notifications may be of various types, one example of which includes a picture of a medication to be administered to the individual. For instance, the picture may depict the container in which the medication is contained, or the actual dosage of the mediation, such as by showing the specific pill or pills to be taken. A dynamic link (textual or graphical) may also be provided that enables contextual phone dialing to a dispensing pharmacist or a clinical care coordinator for the patient (e.g., a nurse educator). Another type of visual alert may be, as an example, illumination on the individual's electronic device (e.g., a flashing LED), accompanied by a textual or graphical display to provide clinical context to the visual alert. The system and methods may employ various types of audible alerts, such as a voice message in the appropriate clinical context, or other audible sounds (e.g., a beeping noise, etc.), as well as vibratory effects, which may also be accompanied by a textual or graphical display to provide clinical context to the respective alert.

Through the system and methods of the present invention, the delivery of important clinical event information to specific individuals may be automated without requiring that inputting the medication schedule manually by the remotely located user.

As referenced above, electronic medical records (EMR) are typically associated with each patient encountering a healthcare provider or system. These health records contain various types of data about an individual patient, such as: patient identifying and demographic information; insurance and financial information; patient health status, such as observed conditions of the patient (e.g., physiological conditions such as blood pressure, oxygen saturation levels in blood, or other “vital signs”), current immunizations, food and drug allergies, diagnoses and current assessments of various clinicians; and care documentation including a listing of clinicians that are currently providing or that have provided care to the patient, clinical orders made (e.g., medications prescribed, tests or procedures ordered, and any entities or providers associated therewith), whether currently valid orders or past orders, and any corresponding insurance or medical claims for coverage of the ordered items. It should be understood that the patient data described herein is not an exhaustive list, and any portion of the described patient data (or any patient data not explicitly set out herein) may reside within a health record. Any or all of the information in the electronic health record may be organized into one or more structured charts within the record, and as one example, the EMR may take the form of a continuity of care record (CCR), a structured information set or record residing with a group of patient-specific records in a community health record (CHR) or health bank, or the like, connected across the community of healthcare providers, consumers and payers.

Furthermore, the term “medical record”, “health record”, “health bank” or “electronic medical record”, should not be interpreted to be limited to any type of computer-readable format or record, but includes any electronically-stored data structure containing information relative to at least one specific patient and from which information may be viewed and/or extracted by various components of the computing system environment 20, such as remote computers 28. Additionally, it should be noted that the terms “patient”, “person” and “individual” are used interchangeably herein and are not meant to limit the nature of the referenced individual nor imply any particular relationship between the individual in question and clinicians or other persons having access privileges to patient-centric health record information. Clinicians, as referred to herein, may include, but are not limited to, a treating physician or physicians, specialists such as surgeons, radiologists and cardiologists, emergency medical technicians, physicians' assistants, nurse practitioners, nurses, nurses' aides, pharmacists, dieticians, microbiologists, laboratory experts, genetic counselors, researchers, veterinarians, students, and the like, and aides or assistants thereto.

Medical claims, as referenced above, generally relates to services rendered by clinicians or providers to particular patients (e.g., medication prescriptions, patient assessments/diagnoses or treatments performed by clinicians, labs, medical equipment, procedures ordered, or other services provided) for which a reimbursement is sought, and may be acquired from various sources including a claims database and a patient's health records (e.g., EMR) and/or a community health record. The claims database may be generated and maintained, for example, by claims payers, such as insurance companies providing prescription drug coverage to individuals, or by a service commissioned by the claims payers. The data forming the claims may be input manually into the database or electronically uploaded from a remote location, such as from a computing system of a clinician or other healthcare provider. Additionally, claims data associated with a particular patient may be uploaded periodically to the patient's health records.

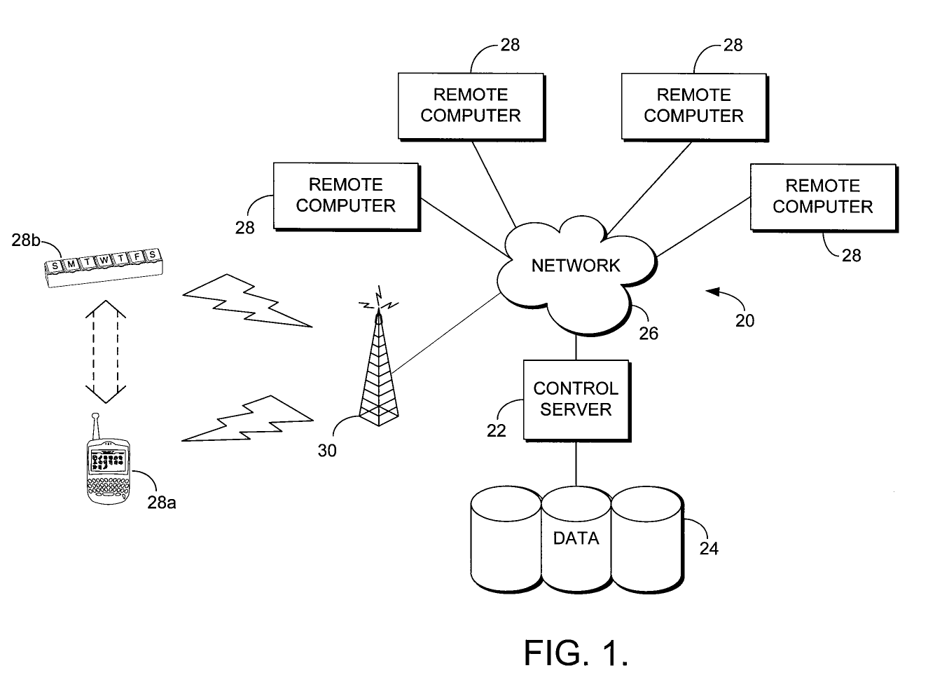

Referring now to the drawings in general, and initially to FIG. 1 in particular, an example of a suitable computing system environment in which the invention may be implemented, for instance, a medical information computing system, is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 20 includes a general purpose computing device in the form of a control server 22. Components of the control server 22 may include, without limitation, a processing unit, internal system memory, and a suitable system bus for coupling various system components, including database cluster 24, with the control server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes therein, or has access to, a variety of computer readable media, for instance, database cluster 24. Computer readable media can be any available media that may be accessed by control server 22, and includes volatile and nonvolatile media, as well as removable and nonremovable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, DVD or other optical disk storage, magnetic cassettes, magnetic tape, magnetic disk storage or other magnetic storage device, or any other medium which can be used to store the desired information and which may be accessed by control server 22. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media

The computer storage media discussed above and illustrated in FIG. 1, including database cluster 24, provide storage of computer readable instructions, data structures, program modules, and other data for control server 22.

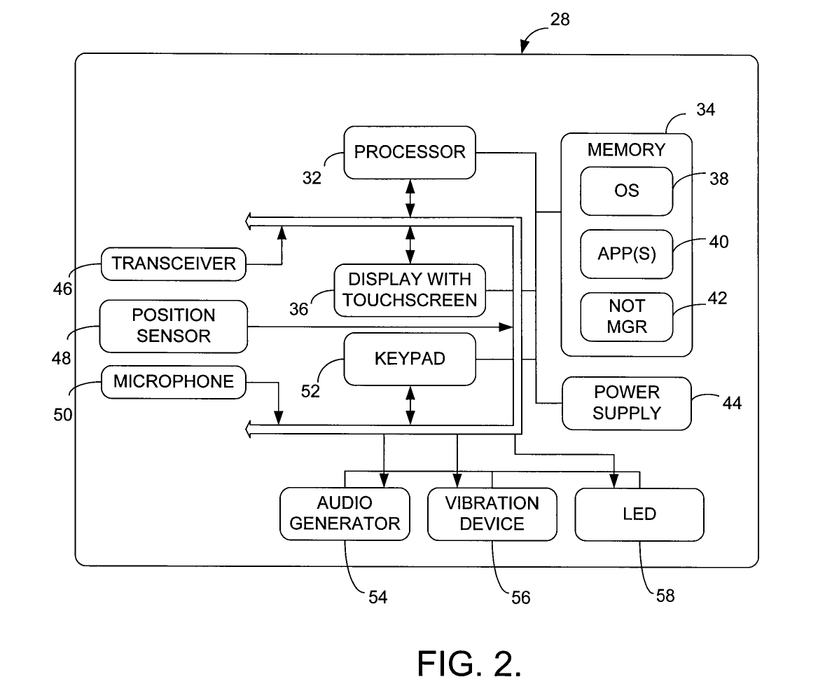

The control server 22 may operate in a computer network 26 using logical connections to one or more remote computing devices or computers 28. Remote computers 28 may be located at a variety of locations in a medical environment or research environment, for example, but not limited to, clinical laboratories, hospitals and other inpatient settings, veterinary environments, ambulatory settings, medical billing and financial offices, administration settings, home health care environments, clinicians' offices, or any other healthcare provider or administrative settings. Remote computers 28 may also be physically located in non-traditional medical care environments so that the entire health care community may be capable of integration on the network. Remote computers 28 may be personal computers, servers, routers, network PCs, personal digital assistants (PDA), peer devices, other common network nodes, or the like, and may include some or all of the elements described above in relation to the control server 22. Still further, with respect to computing devices 28 in the form of remote electronic communication devices 28a and 28b, as is explained more fully herein with respect to FIG. 2, these devices may be assigned to or otherwise associated with specific patients receiving care. In such a case, the functionality and clinical information handled by the patient remote electronic communication devices 28a and 28b may vary from the computing devices 28 associated with healthcare providers or the administrative side of a healthcare environment or network.

One exemplary remote electronic communication device 28a (the “first device”) shown is a portable communications device, such as a PDA, a mobile cellular phone, a mobile text-pager, or a combination thereof. Another exemplary device functioning as the remote electronic communication device 28b (the “second device”) shown is an electronically controlled medication housing device capable of either one-way or two-way communication. For instance, the medication housing device 28b may have a series of compartments to segment medication doses according to a schedule for administration (e.g., by date and/or dosage time). These compartments can be pre-filled by a pharmacist so that an individual has a supply of prescribed medication that will last a certain amount of time (e.g., one week supply, one month supply, etc.). Another exemplary device is a digital picture frame in communication with the network 26. Such a device may be particularly well-suited for less technologically savvy users such as the old and infirm.

The remote electronic communication devices 28a and 28b may both receive notification and/or command signals directly from the network 26 via a communications node (e.g., a signal transmitting/receiving tower 30), and optionally transmit reply signals directly to the network 26 via the communications node. Alternatively, any communications transmitted and received by the second device 28b (as an electronically controlled medication housing device) may travel directly to and from the second device 28b, so that only the first device 28a communicates directly with the network 26 or any other portion of the computing environment 20. In this way, interactions with the first device 28a by the patient control certain functionality of the second device 28b, such as indications for which compartment to access for medications scheduled to be taken and the receiving of any signals indicating that a compartment was accessed by a user. The communication devices 28a and 28b may be portable or non-portable, but in any case configured for being located remotely from the network 26 (e.g., in the home of the patient). In another embodiment, the first device 28a is a one-way communication device that receives communications but does not transmit any responsive communications to the network 26. It should be understood that communication devices 28a and 28b, as well as other computing devices 28, may communicate with one another and through the network 26 utilizing any data transmission format (over a wired or wireless connection), such as by via an internet protocol (IP), a wireless application protocol (WAP), or a cellular or other radio-frequency format (e.g., Bluetooth), as examples.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the control server 22 may include a modem or other means for establishing communications over the WAN, such as the Internet. In a networked environment, program modules or portions thereof may be stored in the control server 22, in the database cluster 24, or on any of the remote computers 28. For example, and not by way of limitation, various application programs may reside on the memory associated with any one or all of the remote computers 28. It will be appreciated by those of ordinary skill in the art that the network connections shown are exemplary and other means of establishing a communications link between the computers (e.g., control server 22 and remote computers 28) may be utilized.

In operation, a user may enter commands and information into the control server 22 or convey the commands and information to the control server 22 via one or more of the remote computers 28 through input devices, such as a keyboard, a pointing device (commonly referred to as a mouse), a trackball, a touch screen, or a touch pad. Other input devices may include, without limitation, microphones, satellite dishes, scanners, or the like. The control server 22 and/or remote computers 28 may include other peripheral input or output devices, such as speakers, a printer, or a scanner. Input and output functionality specific to the remote electronic communication devices 28a and 28b is explained in further detail herein with respect to FIG. 2.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

Turning now to FIG. 2, an exemplary set of functional components for the remote electronic communication devices 28a and 28b are illustrated. Those of ordinary skill in the art will appreciate that various additional functional components may be included in the devices 28a and 28b, and that certain functional components shown may not be present in the devices 28a and 28b depending on the operational aspects of and features provided by the particular device 28a, 28b. Each device 28a, 28b includes a processor 32, a memory 34, a display 36, and certain input/output means. The memory 34 generally includes both volatile memory (e.g., RAM) and non-volatile (e.g., ROM, PCMCIA cards, etc.). In one embodiment, an operating system 38 is resident in the memory 34 and executes on the processor 32. One or more application programs 40 are loaded into the memory 34 and run on the operating system 38. A notification manager 42, for handling notification requests from the applications 40, may also be loaded into the memory 34 for execution on the processor 32. The processor 32 may alternatively be in the form of an application specific integrated circuit (ASIC), such as in the case of a mobile cellular phone, so that applications 40 reside on the processor 32. The remote device 28a, 28b also has a power supply 44 which may be implemented as one or more batteries and/or as an external power source, such as through an AC adapter or a powered docking cradle.

Input and output for the remote device 28a, 28b is made through various components. A transceiver 46 (acting as a receiver), a position sensor 48, a microphone 50, the display 36 (acting as a touchscreen), and a keypad 52 receive input, with an audio generator 54 (e.g., a speaker), a vibration device 56, and an LED 58, as well as the transceiver 46 (acting as a transmitter) and the touchscreen display 36, generating or handling output, each component being coupled with a bus for communication with the processor 32 and other components (e.g., memory 34) and for receiving power from power supply 44. The transceiver 46 transmits and receives signals for communication with components of the computing system environment 20, including another remote device 28a or 28b. For instance, the transceiver 46 may transmit signals generated by the processor 32 based on certain inputs to the remote device 28a, 28b provided by the user. In the case of the remote device 28 being an electronically controlled medication housing device (e.g., for the second device 28b), the position sensor 48 senses when a portion of the housing device is moved, such as when a compartment area is opened to access specific medication doses.

It should be understood that the remote devices 28a, 28b are presented as two-way communication devices, but may alternatively only receive transmitted signals without reply functionality. In such an embodiment, the transceiver 46 may be replaced by a receiver without transmission capability (e.g., in the case of a television set). Additionally, although not shown in FIG. 2, input/output ports may be coupled with the processor 32, so that other electronic devices may interact with the remote devices 28a, 28b. For instance, a barcode scanner or other scanning device may interface with the input/output ports (and connect to the bus) so that identification may be made of a medication from a respective container that has markings that may be scanned.

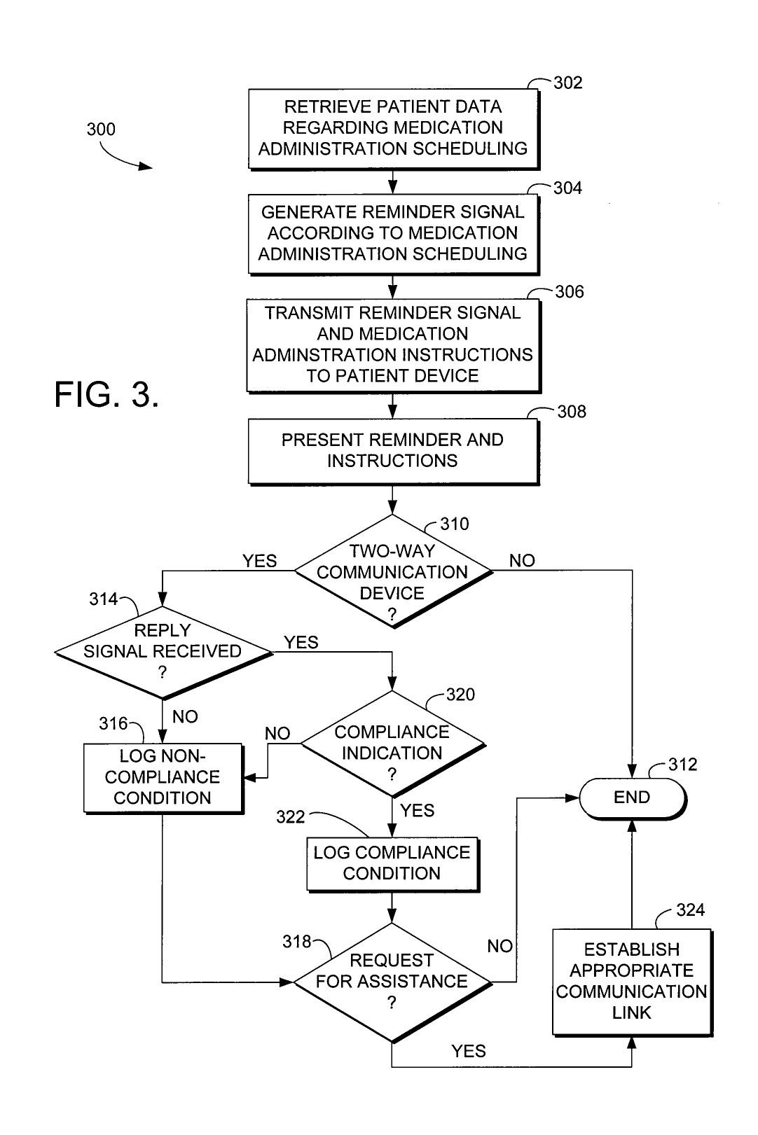

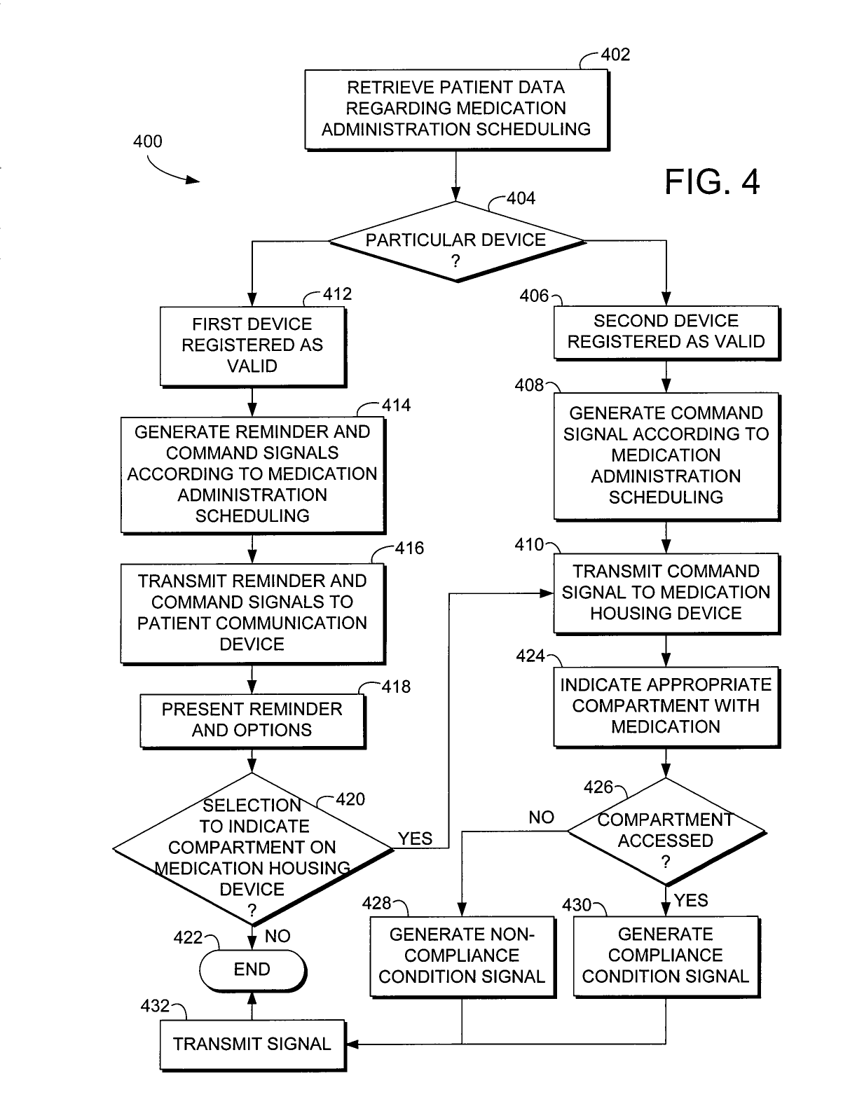

With reference to FIGS. 3 and 4, exemplary computerized methods are illustrated for providing healthcare notifications and managing compliance related feedback, the methods being depicted generally as reference numerals 300 and 400, respectively. The particular method steps depicted in FIGS. 3 and 4 are related to delivering and managing clinical notifications in the context of medication administration scheduling for a specific individual. As those of skill in the art will appreciate, various steps of the methods 300 and 400 are applicable for delivering clinical notifications in other contexts, and for handling feedback associated with the specific individual in other ways.

Turning to FIG. 3, computerized method 300 involves delivering medication administration reminders and handling various feedback situations. Initially, as represented at step 302, patient data relating to the scheduling of prescription medication administration is retrieved from a source of healthcare-type information. For instance, the information source may be from the patient's electronic health record and/or medical claims (e.g., from a claims database or as claims data stored in the patient's health record). The patient health record may also be part of a group record, such as a community health record.

A reminder signal is generated, in step 304, based on the administration scheduling for the patient's medications. The reminder signal informs the patient as to the appropriate time to take a specific dose of a medication, or alternatively may include multiple dosage administration times according to the schedule for the prescription. The patient associated with the reminder may choose to self-administer the medication dosage, or optionally have a responsible person administer the dose to them. Depending on the format for the reminder that is ultimate provided on the patient's electronic device 28a, 28b, the reminder signal may indicate that the patient is to take the medication dose immediately when the reminder is received, or provide information as to when the medication dose is to be taken. As an example, if the reminder signal results in only a visual or vibratory alert being produced on the electronic device 28a, 28b, or if graphical, textual, or audible information produced indicates as such, the patient is being instructed to take the dose immediately or soon thereafter. Other graphical or textual displays, or audible alerts, may alternatively inform the patient as to when to take a medication dose.

Thereafter, in step 306, the reminder signal is transmitted, along with any medication administration instructions (or other relevant clinical information), to the electronic device 28a, 28b associated with the patient. Responsive to the reminder signal received, the device 28a, 28b produces an appropriate response in step 308. For example, the medication administration reminder and other accompanying information may be displayed in a graphical or textual form on the first device 28a (i.e., as a PDA, a mobile cellular phone, a digital picture display, etc.). Alternatively, in the case of the second device 28b being an electronically controlled medication housing device, visual or audible indications may be produced by the second device 28b to indicate that a particular medication dose (e.g., within an indicated compartment of the device 28b) should be administered. If the reminder signal includes information for multiple dosage events according to scheduled administration, then the device 28b, 28b continues to produce the appropriate response according to the schedule.

A determination is then made as to whether the electronic device 28a, 28b is a two-way communication device, in step 310. If the electronic device 28a, 28b does not possess two-way communication functionality, and thus only receives transmitted signals, then the method concludes at endpoint 312. Alternatively, if the patient's electronic device 28a, 28b is capable of two-way communication, then in step 314, a determination is made as to whether a reply signal generated by the device 28a, 28b has been received (e.g., received by the computing system 20). The reply signal is generated and transmitted by the device 28a, 28b in response to, for instance, inputs made on the device 28a, 28b or conditions sensed by the device (e.g., by position sensor 48). The device 28a, 28b may also be polled intermittently for a reply, or the computing system 20 may wait a predetermined period of time to receive a reply signal from the particular device 28a, 28b. If a reply signal is not received, then in step 316, a “non-compliance” condition is logged for association with the particular patient. The non-compliance condition may be logged in the specific patient's health record, as one example, so that clinicians providing care are aware of the patient missing a medication dose. Further, in response to logging of the non-compliance condition, the medication administration for the patient may be modified to take into account, for example, medication doses that were never indicated to have been taken. Thereafter, new reminder signals and medication administration instructions may be generated and transmitted to the patient regarding the next medication dosage administration. For instance, the instructions may indicate that the patient should increase their next medication dosage amount to a specific dosage size, or may inquire as to whether the patient has now eaten anything. If the patient were to indicate on their device 28a, 28b that food had been consumed, and the medication was only to be ingested prior to a meal, then another new set of medication administration instructions are sent to the patient device 28a, 28b, for example, instructing the patient to not take the missed dose and to wait for a future reminder signal prior to taking another dose. Subsequent to logging a non-compliance condition, the method moves to step 318.

Returning to step 314, if a reply signal is received from the appropriate electronic device 28a, 28b, then whether the reply signal indicates compliance with the medication administration reminder is determined in step 320. If the reply signal does not indicate compliance, then the method proceeds to step 316 where a non-compliance condition is logged. On the other hand, if the reply signal indicates compliance, then a “compliance” condition is logged for association with the particular patient, in step 322.

The method 300 then proceeds to step 318, where a determination is made as to whether the reply signal transmitted by the device 28a, 28b includes a request for assistance from the patient. As one example, a request may be initiated by selecting one of a number of dynamic links displayed on the electronic device 28a, 28b in conjunction with the reminder and medication administration instructions. If the reply signal does not include a request for assistance, then the method concludes at endpoint 312. Alternatively, the inclusion of a request for assistance in the reply signal causes an appropriate communication link to be established to the device 28a, 28b, in step 324. For instance, the communication link may be made over a cellular network, IP network, or other appropriate network, so that the patient may receive assistance in a selected format (e.g., voice, graphical or textual data, etc.). Subsequent to step 324, the method concludes at endpoint 312.

Turning to FIG. 4, computerized method 400 is provided for handling of healthcare reminders and related access to preselected medications in accordance with medication administration scheduling. Initially, as represented at step 402, patient-specific data relating to the scheduling of prescription medication administration is retrieved from a source of healthcare information, such as the patient's health record or medical claims.

A determination is then made as to the particular type of electronic device 28a, 28b that is associated with the respective patient, in step 404. The device 28 may be, for instance, the first device 28a in the form of a patient communication device (e.g., a mobile cellular phone, or other similar two-way communication device, whether portable or non-portable). Alternatively, the device 28 may be the second device 28b, such as an electronically controlled medication housing device.

Accordingly, when it is determined that the device 28 is the second device 28b, the second device is registered as valid, in step 406. A command signal is then generated based on the administration scheduling for the patient's medications, in step 408. In one embodiment, the command signal instructs the second device 28b to generate an indication that the command signal is received, either at the time it is actually received or at a later time when a medication dose should be administered according to the respective schedule. With the electronically controlled medication housing device 28b, for instance, the indication may be a visual or audible indication regarding a specific compartment to be accessed for removal of one or more pre-selected medication doses according to the administration schedule. Thereafter, in step 410, the command signal is transmitted to the electronically controlled medication housing device 28b.

Alternatively, in step 404, when it is determined that the device 28 is the first device 28a, the first device is registered as valid, in step 412. Reminder and command signals are generated, in step 414, based on the generated based on the administration scheduling for the patient's medications. The reminder signal informs the patient as to the appropriate time to take a specific dose of a medication, or alternatively may include multiple dosage administration times according to the schedule for the prescription. In one embodiment, the command signal instructs the first device 28a to generate options for the patient to select, whereby certain selections by the patient cause the first device 28a to pass on the command signal (or generate a new command signal for transmission) to the electronically controlled medication housing device 28b. The reminder and command signals are then transmitted to the first device 28a, in step 416. The first device 28a displays the reminder and options related to the command signal, in step 418, so that the user (patient) may make appropriate selections on the first device 28a. At this point, a determination is made in step 420 as whether the user made a selection to indicate the appropriate compartment on the medication housing device 28b in which the proper medication dosage to be administered is located. If the user does not select to have an indication made by the medication housing device 28b, then the method concludes at endpoint 422. On the other hand, if the user selects to have the medication housing device 28b provide the appropriate indication, the method 400 moves to step 410, where the command signal is transmitted to the medication housing device 28b.

Once the electronically controlled medication housing device 28b receives the command signal, the device 28b generates an indication of the appropriate compartment to be accessed, in step 424. Whether the appropriate compartment is eventually accessed, or accessed within a set period of time from when the indication was made by the device 28b, is determined in step 426. For instance, one or more position sensors 48 on the second device 28b (FIG. 2) may detect if any particular compartment is opened, including a compartment associated with the appropriate medication doses to be administered in accordance with the schedule. If the appropriate compartment is accessed within any time limit, then a “compliance” condition signal is generated in step 428. Otherwise, if the appropriate compartment is not accessed within a pre-defined time limit, a “non-compliance” condition signal is generated, in step 430. The appropriate signal registering a compliance or non-compliance condition is then transmitted back through the system 20, in step 432. In embodiments, the compliance or non-compliance condition may be stored in the specific patient's health record, for access and review by the patient's physician.

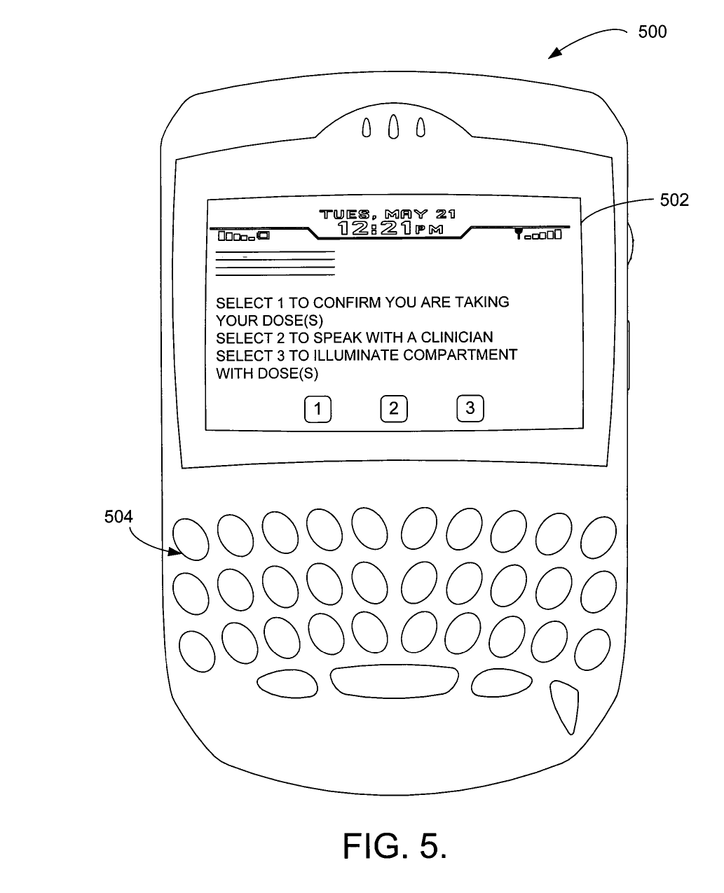

With respect to FIG. 5, an exemplary patient-specific electronic communication device 500 (e.g., functioning as first device 28a) is shown with a touchscreen display 502 for providing various clinical notifications, such as reminders and other information, as well as dynamic selectable options. The device 500 may provide a graphical representation of a medication dose to be taken, textual information regarding the specific medication, or any other type of information or indication (e.g., visual, audible, vibratory, etc.). With the exemplary device 500, a user may make selections on the keypad 504 or directly on the touchscreen display 502 in response to the notifications displayed. For instance, by selecting option “1”, the device 500 generates and transmits a confirmation signal regarding compliance with medication dosage administration. The selection of option “2” causes the device 500 to initiate a call (e.g., over a wireless telecommunications network) to a clinician or other person (i.e., a community health advisor) that can provide information regarding medication administration. The device 500 makes the call to the appropriate phone number based on the command signal received. As an example, the phone number may exist in a database of the medical information system 20, which is accessed in generating the command signal. Finally, the selection of option “3” cause the device 500 to generate and transmit a command signal to the electronically controlled medication housing device 28b, instructing the device 28b to illuminate the appropriate compartment containing the medication dose to be taken in accordance with the administration schedule.

From the foregoing, it can be seen that various embodiments of the system and methods of the present invention provide for delivering person-specific clinical notifications. In embodiments, the notifications are generated by relying on sources of healthcare-type information. In certain embodiments, the notifications include reminders relating the administration of a particular medication dose, which are transmitted to electronic devices associated with the respective persons. Thereafter, compliance information regarding medication administration may be registered. In additional embodiments, patient information such as blood pressure, glucose levels, and the like may be received by the devices 28 along with, or as a condition prior to, the administration of a medication or other clinical event. As such, the method may provide a more comprehensive system for disease or condition management.

The aforementioned system and methods have been described in relation to particular embodiments, which are intended in all respects to be illustrative rather than restrictive. Since certain changes may be made in the aforementioned system and methods without departing from the scope hereof, it is intended that all matter contained in the above description or shown in the accompanying drawing be interpreted as illustrative and not in a limiting sense.

What is claimed is:

1. A computerized method for providing to a remotely located individual information relating to medications associated with the individual, comprising:
acquiring medication information from a source of healthcare information associated with the remotely located individual;
generating a signal based on the medication information; and
transmitting the signal to an electronic device associated with the remotely located individual.

2. The method of claim 1, wherein the source of healthcare-type information is at least one of:
one or more medical claims; and
a health record of the remotely located individual.

3. The method of claim 2, wherein the health record is part of a community health record.

4. The method of claim 1, wherein generating a signal is performed automatically based on timing parameters present in the medication information.

5. The method of claim 1, wherein the signal generated includes a reminder of at least one of the following types:
scheduled medication administration for the remotely located individual; and
a prescription renewal for the remotely located individual.

6. The method of claim 1, wherein the signal generated includes at least one of:
a notification related to a scheduled administration time for a specific medication;
instructions for administering a specific medication;
contact information for an entity providing information surrounding the administration of a specific medication; and
a command signal instructing the electronic device associated with the remotely located individual to establish a communication link with an entity providing information surrounding the administration of a specific medication.

7. The method of claim 1, wherein the electronic device associated with the remotely located individual is a medication housing device, and wherein the signal generated includes a command signal instructing the medication housing device to provide an indication of the receiving of the command signal.

8. The method of claim 7, wherein the indication provided by the medication housing device directs the individual to remove preselected medications from the device.

9. A computer-readable medium having computer-executable instructions for performing the method of claim 1.

10. A method for managing electronic communications surrounding healthcare reminders, comprising:
acquiring clinical information from a source of healthcare-type information associated with a remotely located individual;
generating a reminder signal based on the clinical information; and
transmitting the reminder signal to an electronic device associated with the remotely located individual.

11. The method of claim 10, wherein the source of healthcare-type information is at least one of:
one or more medical claims; and
a health record of the remotely located individual.

12. The method of claim 11, wherein the health record is part of a community health record.

13. The method of claim 10, further comprising:
receiving a reply from the electronic device associated with the remotely located individual in response to the transmitted reminder signal;
wherein the reply includes at least one of:
an indication as to whether the remotely located individual received a notification regarding scheduled medication administration,
an indication that the remotely located individual plans to or has complied with a scheduled medication administration event,
a request for information regarding a specific medication, and
a request for assistance regarding medication administration.

14. The method of claim 13, further comprising:
storing information in a health record of the remotely located individual relating to any indication from the individual that compliance with a scheduled medication administration event has occurred.

15. The method of claim 10, wherein the reminder signal generated includes a reminder of at least one of the following types:
scheduled medication administration for the remotely located individual;
a scheduled appointment for the remotely located individual; and
a prescription renewal for the remotely located individual.

16. A computer-readable medium having computer-executable instructions for performing the method of claim 10.

17. A computerized method for facilitating compliance with scheduled medication administration for a remotely located individual, comprising:
generating a reminder signal based on an administration schedule for a specific medication, wherein the administration schedule is acquired from a source of healthcare-type information associated with the remotely located individual;
transmitting the reminder signal to an electronic device associated with the remotely located individual; and
receiving a reply from the electronic device indicative of activity surrounding the scheduled administration of the specific medication.

18. The method of claim 17, wherein the electronic device is a portable communication device, and wherein the reminder signal includes a command signal instructing the portable communication device to:
generate a second command signal instructing a medication housing device to provide a particular indication of the receiving of the second command signal for directing the remotely located individual to remove preselected medications from the medication housing device; and
transmit the second command signal to the medication housing device.

19. The method of claim 18, wherein the reply received from the electronic device indicates that the electronic device received from the medication housing device a signal indicating that contents of the medication housing device were accessed.

20. The method of claim 17, wherein the reply signal includes an indication of at least one of:
whether the remotely located individual received a notification regarding scheduled administration of the specific medication;
whether the remotely located individual plans to or has complied with a scheduled medication administration event;
a request for information regarding the specific medication; and
a request for assistance regarding administration of the specific medication.

21. The method of claim 17, wherein the source of healthcare-type information is at least one of:
one or more medical claims; and
a health record of the remotely located individual.

22. The method of claim 21, wherein the health record is part of a community health record.

23. A computer-readable medium having computer-executable instructions for performing the method of claim 17.
